(19) United States
(12) Patent Application Publication
(10) Pub. No.: US 2007/0157230 A1
(43) Pub. Date: Jul. 5, 2007

(54) Selective television advertising

(75) Inventor: Aris Mardirossian, Germantown, MD (US)

Correspondence Address: NIXON & VANDERHYE, PC, 901 NORTH GLEBE ROAD, 11TH FLOOR, ARLINGTON, VA, 22203, US

(73) Assignee: Technology Patents LLC, Derwood, MD (US)

(21) Appl. No.: 11/319,744

(22) Filed: Dec. 29, 2005

(51) Int. Cl. H04N 7/173; H04N 5/445; H04N 7/10; H04N 7/025; G06F 13/00; G06F 3/00

(52) U.S. Cl. 725/35; 725/34; 725/46; 725/112; 725/113

(57) ABSTRACT

A system and/or method for displaying television advertisements based on users' demographic data is provided, and, in certain example embodiments, a system and/or method is provided for matching a user with a predefined category from a plurality of predefined categories based on collected demographic data. In certain example embodiments, custom categories are defined and demographic data for potential consumers is collected. Users or potential consumers are matched to at least one category based on the collected demographic data. Based at least partially on such matching, appropriately targeted advertisements are sent to consumers during breaks in the primary content (e.g., during breaks in a primary television show such as a sporting event or soap opera).

### FIELD OF THE INVENTION

This invention relates to a system and/or method for displaying television advertisements based on users' demographic data or the like. In certain example embodiments, a system and/or method is provided for matching a user with a predefined category or categories from a plurality of predefined categories based on collected demographic data, and delivering custom advertisements to that user's television.

### BACKGROUND AND SUMMARY OF EXAMPLE EMBODIMENTS OF THE INVENTION

Traditionally, advertisers disseminate mass media messages to large audiences to peddle their wares. Typically, they advertise through a variety of media outlets including, for example, newspapers, magazines, radio, television, etc. This strategy for advertising attempts to reach the largest possible audience at the lowest possible cost. In conventional television advertising for example, the same ads (or advertisements) are typically sent to all viewers of a particular show on a given channel, regardless of what demographics may be associated with such viewers.

Yet, at least two factors suggest that this approach is less than optimal. First, advertisers effectively over-advertise because many of the people they reach, for any host of reasons, will not purchase their products. For example, consumers may not want or need the product, potential customers might see an advertisement and select a competitor's product, or potential future customers may be turned-off by the advertisement because they are not yet ready to purchase it. Thus, over-advertising may result in wasted advertising money.

Second, advertisers effectively under-advertise because they do not always reach the customers who are most likely and most willing to purchase their products. Clearly, not all interested parties watch television or listen to the radio at the time the advertisement is broadcast. Some consumers might see an advertisement for a competitor's product, and, without knowing of the alternatives, purchase that product. Thus, under-advertising may result in lost customers.

With the proliferation of more advertisements across more media channels and with a prospective customer's time increasingly at a premium, advertisers have had to refine their respective bulk broadcast strategies. Accordingly, many advertisers have tried to target their advertisements to avoid the above-described problems and generate a higher return per advertising dollar spent. Some advertisers or their agents may collect data, such as, for example, individual demographic data, household information, spending data, etc. Based on predefined heuristics, this data may be processed to place potential consumers into predefined groups. Then, advertisements may be targeted to those users.

Attempts to deliver targeted advertisements, for example, send all users in a certain zip code or neighborhood a selected group of advertisements through the mail. Yet, this form of advertising still lacks specificity, especially because of the increasing diversity within communities and the number of mixed-use communities developing. Another example includes, for example, advertising to certain magazine subscribers—for example, subscribers of hunting magazines might reasonably be interested in products related to the outdoors. However, this form of advertising relies on a symbiotic relationship between two parties. Additionally, the information delivered to advertisers is relatively static, is not geared to the whole of the potential multiplicity of types of readers of the magazine, and is not updated with regularity.

An example non-limiting disadvantage of these and other types of advertising is that they are not updated with regularity. Another example non-limiting disadvantage of these types of advertising is that they risk miscategorizing consumers. Miscategorizing consumers from the beginning may, for example, lead to wasted advertising money and may additionally build resentment towards product. The miscategorizations may take place initially, or may result from changing conditions among consumers. For example, single males living alone might get married one year and have children the next, thus necessitating a corresponding change by advertisers within a reasonable period of time.

Some television advertisement systems have tried to overcome these disadvantages. FIG. 1 is an illustrative conceptual view of a media stream containing content and advertisements, in general, for television. Media stream 100 is comprised of advertisements surrounded by Content₁ and Content₂. A single advertisement, or a plurality of advertisements (Ad₁ to Adₙ) may comprise advertising stream 102. In some prior art systems, advertising stream 102 is changed depending on the group to which the viewer/listener is assigned.

Some television advertisement systems, for example, build databases based on viewer habits and then use the collected data to classify viewers. These systems have the advantage of potentially being updatable and customized for each household. Such systems are disclosed in U.S. Pat. No. 5,600,364 to Hendricks et al. and U.S. Pat. No. 6,718,551 to Swix et al. However, such systems require expensive custom hardware at the viewers' homes and significant computing power to process and parse the incoming media stream. Additionally, such systems are limited to the amount of information they can collect. While these systems may optionally incorporate other information, additional computing power is needed to match the data from disparate sources, and the resulting dataset often still is limited to data collected by the provider.

Even when a sufficiently broad amount of data can be collected and categorized, many technical difficulties relating to the receiving of targeted advertisements arise. For example, special hardware still is needed to receive the custom advertisements. Some systems create custom “channels” that broadcast only advertisements, and they can be switched to transparently during regular programming breaks. However, these systems, like the ones disclosed in the patents to Hendricks et al. and Swix et al., present synchronization problems among different users watching different channels. Again, custom hardware may be required to perform complex retrieving, storing, decompression, and displaying routines to prepare the advertisements for consumers.

Other targeted television advertising schemes also exist, but they suffer similar disadvantages. For example, FIG. 2A is an exemplary view of a system that displays advertisements based on certain user demographics. A plurality of times 210 (Time₁ to Timeₙ) is listed, as are a plurality of channels 212 (#₁ to #ₙ). Program listing area 214 lists the available programming for a given time-channel pairing. An advertisement is displayed in advertising area 216. This system may target advertisements to viewers, but the advertisements are only displayed when a user accesses the program listing function—for example, they typically are not interspersed with media steam 100 from FIG. 1. Advertisements according to this system typically are customized, for example, based on the time the viewer is watching television. Typically, in the system depicted in FIG. 2A, advertisements are not started and stopped when particular users access the program listing function. Rather, advertisements run continuously, and a viewer may encounter an advertisement in “mid stream.”

Similarly, FIG. 2B is an exemplary view of another system that displays advertisements based on certain user demographics. A plurality of times 220 (Time₁ to Timeₙ) are listed, as are a plurality of channels 222 (#₁ to #ₙ). Program listing area 224 lists the available programming for a given time-channel pairing. Information about the selected program may appear in selected program information area 226. An advertisement is displayed in advertising area 228, which may be customized, for example, based on the time the viewer is watching television, the program selected for display, and/or the category displayed. While these advertisements may be started and stopped when particular users access the enhanced program listing function, advertisements still are only displayed when a user accesses the program listing function—for example, they typically are not incorporated into media steam 100 from FIG. 1.

Given the number of deficiencies in conventional advertising systems, both targeted and untargeted, it will be appreciated that there exists a need in the art for a method and/or system for displaying television advertisements based on users' demographic data that are, for example, flexible, updatable, and/or easy to implement. Moreover, in certain example non-limiting instances, it may be advantageous to be able to implement such a system without home users having to purchase special hardware.

In certain example embodiments, a system for displaying targeted advertisements comprises at least one custom category, a database of demographic data including at least one characteristic for a potential consumer and a unique addressable location for the potential consumer, a matcher for associating the potential consumer with at least one custom category, a processor for generating a customized media stream of generic content and at least one targeted advertisement for the potential consumer, and a broadcasting mechanism for disseminating to the addressable location the customized media stream.

In certain example non-limiting embodiments, the demographic data is obtained from a credit card company or the like. In other example non-limiting embodiments, the broadcasting mechanism disseminates media streams by one or more of a cable television system, a satellite television system, standard broadcast television, and/or the Internet. In still other example non-limiting embodiments, the database of demographic data is updatable, and the association between the potential consumer and the at least one custom category is updated when or after the database of demographic data is updated. In certain example embodiments, the matcher associates a potential consumer with at least one custom category through the use of one or more of a predefined heuristic, a custom user operation, standardized industry groupings and/or a mathematical clustering technique. And in still other example embodiments, the at least one custom category is based on at least one of an industry standard list, a consumer's preference, and/or a mathematical clustering technique.

In certain other example embodiments, a system for displaying targeted advertisements comprises at least one custom category, a database of demographic data including at least one characteristic for a potential consumer, a matcher for associating the potential consumer with at least one custom category, a processor for generating a media stream of content and all potential targeted advertisements for all potential consumers, a broadcasting mechanism for disseminating the media stream, and a filter that eliminates targeted advertisements that do not match the association created by said matcher. In certain non-limiting embodiments, the targeted advertisements are compressed before transmission and decompressed before display.

In certain example embodiments, a method for displaying targeted advertisements comprises the following steps of defining at least one custom category, obtaining a database of demographic data including at least one characteristic for a potential consumer and a unique addressable location for said potential consumer, matching said potential consumer with at least one custom category, generating a customized media stream of generic content and at least one targeted advertisement for said potential consumer, and broadcasting to said addressable location said customized media stream.

In still other example embodiments, a method for displaying targeted advertisements comprises the following steps of defining at least one custom category, obtaining a database of demographic data including at least one characteristic for a potential consumer, matching said potential consumer with at least one custom category, generating a media stream of content and all potential targeted advertisements for all potential consumers, broadcasting said media stream, and filtering said media stream to eliminates targeted advertisements that do not match.

While certain preferred embodiments relate to displaying customized advertisements via televisions, this invention is not so limited. For example, in alternative embodiments of this invention the customized advertisements may be broadcast via radio (e.g., satellite radio).

### BRIEF DESCRIPTION OF THE DRAWINGS

These and other features and advantages will be better and more completely understood by reference to the following detailed description of exemplary illustrative embodiments in conjunction with the drawings, of which:

FIG. 1 is an illustrative conceptual view of a media stream containing content and advertisements;

FIG. 2A is an exemplary view of one conventional system that displays advertisements based on certain user demographics;

FIG. 2B is an exemplary view of another conventional system that displays advertisements based on certain user demographics;

FIG. 3A is a partial schematic view of a system in accordance with a first example embodiment;

FIG. 3B is a partial schematic view of a system in accordance with a second example embodiment;

FIG. 4A is a flowchart in accordance with a first example embodiment; and,

FIG. 4B is a flowchart in accordance with a second example embodiment.

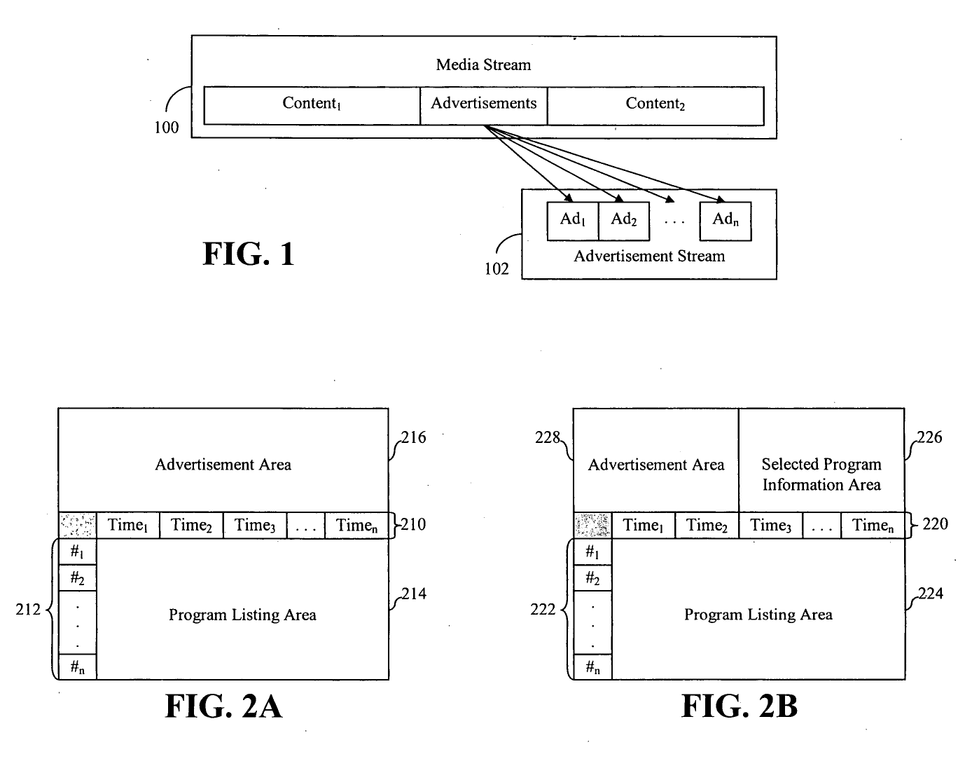

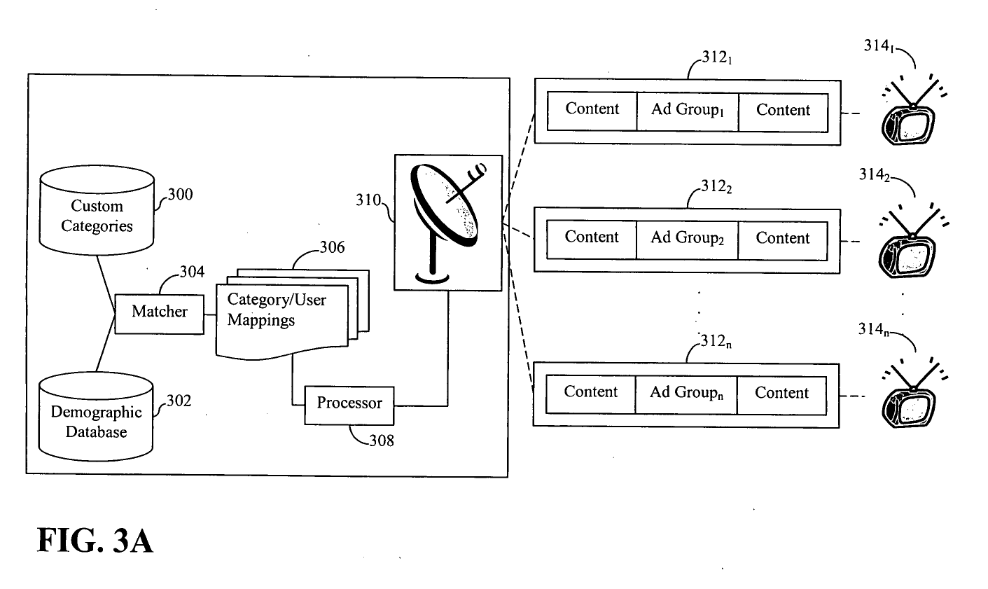

### DETAILED DESCRIPTION OF EXAMPLE EMBODIMENTS OF THE INVENTION OF THE INVENTION

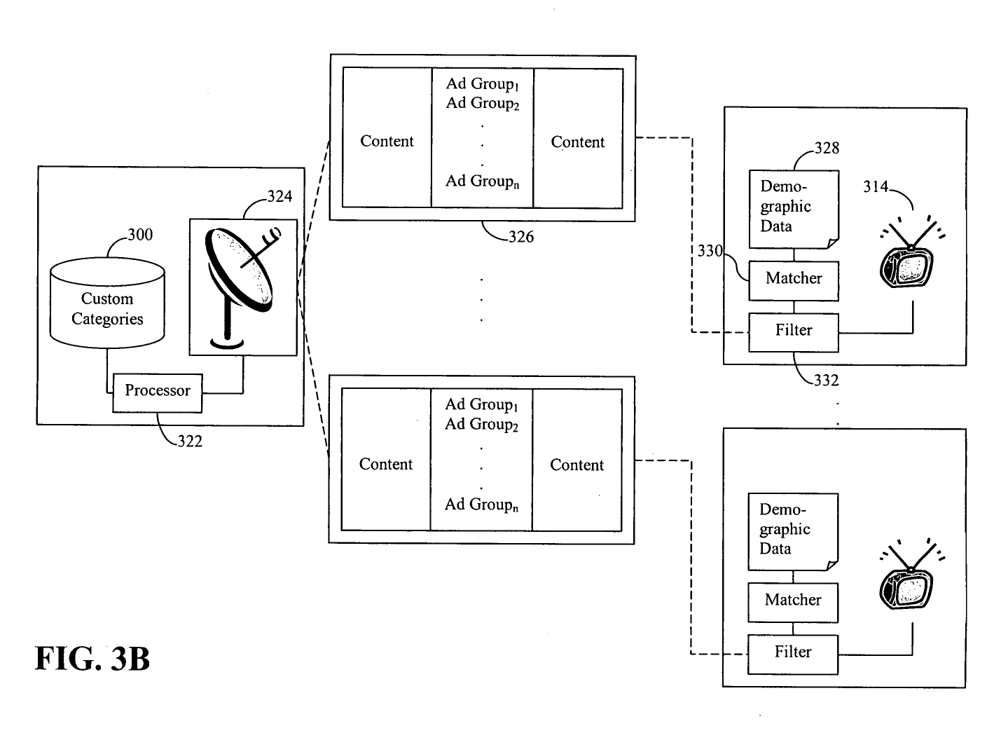

Referring now to the figures, FIG. 3A is a partial schematic view of a system in accordance with a first example embodiment of this invention. This example embodiment includes a database of custom categories 300, which, in turn, comprises a list of categorizations to which consumers will be assigned.

Table 1 is an exemplary, non-limiting list of categorizations, divided primarily into interest, family style, and primary age group. It will be appreciated that other primary divisions are possible and contemplated herein, and that some example embodiments may comprise only one primary categorization. It also will be appreciated that the sub-categorization lists below each primary division are for exemplary, non-limiting purposes only. Indeed, the number and types of sub-categorization lists may be varied, for example, depending on the need, information available, etc.

TABLE 1

| Interest | Family Style | Primary Age Group |
|---|---|---|
| Arts and Entertainment | Single Male | Under 20 |
| Automotive | Single Female | 20-35 |
| Food | Married Couple | 36-50 |
| Health and Personal Care | Family with Children | 50-65 |
| Home and Garden | | 66 and older |
| Outdoors and Travel | | |
| Pets | | |
| Shopping | | |
| Sports and Leisure | | |
| Technology | | |

Preferably, a system according to an example embodiment will combine the categories to tailor the advertising to a specific consumer. For example, using the categories and sub-categories listed in Table 1, it may be possible to deliver targeted advertisements to individuals interested in sports and leisure, who are single males between the ages of 20 and 35. Additionally, it will be appreciated that multiple interests may be combined. Thus, again using the categories in Table 1, for example, it may be possible to deliver targeted advertisements to individuals interested in shopping and pets, who are single females between the ages of 50 and 65. It also will be appreciated that some example embodiments may not use all of the categorizations—for example, some example embodiments may pick one or more interests and a family style without specifying an age.

Combinations of the above categories yields 200 distinct groupings, excluding single categories and combinations of two categories. The number of groupings in an embodiment may be customized, depending on, for example, the amount of information available, the computing power available for delivering custom content, etc. Groupings, for example, may be customized by the provider qualitatively, according to industry-established practice and/or market data, a more mathematical clustering technique specific to the dataset collected, etc. Preferably, at least 10 distinct groups will be specified, and, more preferably, at least 20 distinct groups will be specified. It will be appreciated that too few or too many categorizations may not adequately target advertisements.

Demographic data is stored in demographic database 302. Demographic database 302 may be created in any number of ways. In preferred embodiments, demographic data is collected from credit card companies. Data preferably is collected in this way because it is accurate, up-to-date, and provides a nearly complete snapshot of a particular consumer's demographic characteristics and spending habits.

Table 2 is an exemplary, non-limiting record that includes data for each consumer. It will be appreciated that a credit card company will provide data on a plurality of consumers, and they may share the following data, in whole or in part, as well as with other data.

TABLE 2

| Field Name | Description |
|---|---|
| Name | Consumer's name |
| SSN | Consumer's Social Security Number |
| Address | Consumer's address |
| Phone | Consumer's phone number |
| Gender | Consumer's gender |
| Age | Consumer's age |
| Race | Consumer's race |
| Kids | Number of children in consumer's household |
| Married | Flag for whether consumer is married |
| HouseType | Flag for the type of home the consumer lives in |
| Occupation | Consumer's occupation |

Table 3 is an exemplary non-limiting record that includes data for each purchase, or a number of purchases, made by a given consumer. It will be appreciated that such records can be customized and may include other data in place of, or in addition to, that which is presented in below. It also will be appreciated that data from a credit card company will include a plurality of such records for each user.

TABLE 3

| Field Name | Description |
|---|---|
| Date | Date of purchase |
| Time | Time of purchase |
| Store | Store where purchase was made |
| StoreID | Identification of store, if a chain |
| StoreLocation | Store location |
| Item | Item purchased |
| Amount | Number of items purchased |
| Price | Amount spent on purchase |
| OnSale | Flag for whether item was on sale |
| CouponUsed | Flag for whether coupon was used |

Spending information such as that depicted in Table 3 may be stored in demographic database 302. Alternatively, it may be stored in another database (not shown) because of, for example, design constraints, desired flexibility, privacy concerns, etc. In still other example embodiments, such data may be stored in a plurality of databases. Of course, it will be appreciated that this fine level of data may not be possible to obtain, and/or necessarily desired. Thus, information of the type represented in Table 3 may not be present at all in certain example instances.

Matcher 304 uses custom categories 300 and demographic database 302 to develop category/user mappings 306. In some example embodiments, matcher 304 applies, for example, a set of rules or heuristics to take the data in demographic database 302 for each consumer and fit each consumer to at least one custom category from custom categories 300. The category/user mappings 306 may reside in a separate database. Preferably, however, category/user mappings 306 may be stored in the demographic database with symbolic links to the custom categories 300. Consumers whose information in demographic database 302 does not match a custom category in custom categories 300 may be, for example, assigned to a default group, flagged for further action, removed from the database, etc.

It will be appreciated that although custom categories 300, demographic database 302, and category/user mappings 306 are depicted as separate entities in FIG. 3A, they may be stored alone, together, or in various combinations. Additionally, it will be appreciated that matcher 304 may be any combination of software or hardware, and may even exist within one or more databases.

Processor 308 may use information from the category/user mappings 306 in combination with regular content to create outgoing media streams 312₁ to 312ₙ. Broadcaster 310 will use the information created by processor 308 to deliver the custom media streams 312₁ to 312ₙ to consumers 314₁ to 314ₙ. It will be appreciated that broadcaster 310 may be operable to broadcast through any medium, such as, for example, cable, satellite, traditional broadcast television signals, the Internet, etc. It also will be appreciated that consumers 314₁ to 314ₙ may view the advertisements on various receivers, such as, for example, televisions, computers, etc.

The plurality of media streams 312₁ to 312ₙ each contain ad groups surrounded by regular content. The ad groups may contain at least one advertisement belonging to a given category. In some example embodiments, if a consumer belongs to multiple categories, the ad group may contain one or more ads from one or more categories. In some example embodiments, the type of ads may be proportional to the degree to which the consumer matches a particular group or groups. For example, if a consumer is a 30 percent match to a sports and leisure group and a 70 percent match to the outdoors and travel group, the ad group may contain a corresponding proportion of advertisements. In still other embodiments, advertisers may pay a premium to have their advertisements displayed to all groups.

The delivery of custom media streams preferably may be accomplished by directly addressing the end-consumers' viewing devices. For example, it is well known and established that cable and satellite companies maintain individual addresses to control subscriber access to, for example, premium channels, pay-per-view events, etc. Certain example embodiments may use the same signal to target advertisements. Traditional broadcast television may be directly addressable by, for example, overlaying broadcast signals with power grids, phone lines, or the like. Internet broadcasts easily may be directly addressed by, for example, sending a signal to a particular IP address. As different forms of media converge and as more bandwidth becomes available over broadcast channels, different and varied ways of directly addressing signals may become possible and are contemplated herein.

It also is well-known to use various recorders, especially digital recorders, to temporarily store media for playback. Some embodiments may require a recording device (not shown) connected to the television to temporarily store advertisements. These devices may reduce processing power required of broadcasters, as synchronization may be accomplished by use a recording device to temporarily store and playback a pre-sent advertisement.

FIG. 3B is a partial schematic view of a system in accordance with a second example embodiment. Components analogous to those in FIG. 3A are correspondingly numbered, and a discussion of these analogous components will be omitted. In this example embodiment, a processor 322 may tag ad groups with their corresponding categories. Then, broadcaster 324 may deliver media streams 326 comprising content and all ad groups to all consumers. Before the media stream is displayed, demographic data 328 and matcher 330 may work with filter 332 to determine which ad group out of the plurality of ad groups should be displayed.

In this embodiment, demographic data may be stored locally at each house, promoting, for example, privacy. Filter 332 may comprise, for example, a custom card, filter, stand-alone device, or the like that works with a display device. This example embodiment requires less processing power when preparing media streams because, for example, all media streams are sent to all consumers. The home-based filtering process also, for example, may provide a unique direct address for the broadcaster 324 to target. It will be appreciated that demographic data 328 may be updatable, for example, by the end-consumer, the broadcaster, an advertiser, etc. Updates may be possible by, for example, providing a new filter 332, updating the new filter in person or remotely through software and or hardware mechanisms, etc.

To save bandwidth during transmission, the plurality of ad groups may, for example, be compressed. Filter 332 or other hardware may provide the corresponding decompression mechanism.

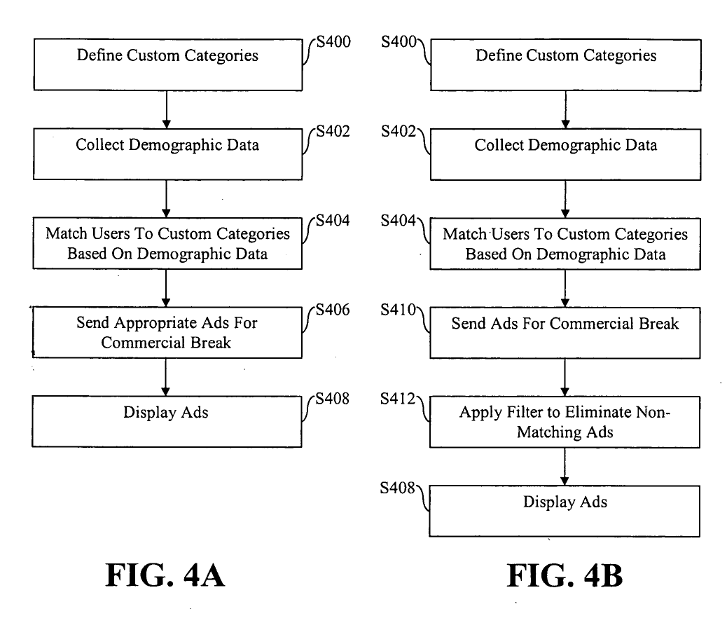

FIG. 4A is a flowchart in accordance with an example embodiment. Custom categories are defined in step S400. Categories may be defined, for example, with reference to industry norms, by advertising agencies, by broadcasters, etc. In step S402, demographic data is collected. As noted above, demographic data preferably is collected from credit card companies. Other example embodiments may collect data from, for example, banks, commercial databases, consumers directly, etc. In step S404, based on a set of matching criteria, demographic data for consumers are matched with the custom categories defined in step S400. Each consumer should be matched to at least one category. In some example embodiments, consumers may be matched to more than one category. In other example embodiments, rules for consumers who do not match a pre-defined category may take appropriate action by, for example, assigning them to default groups, prompting for further backend action, or dropping them from the list of targeted individuals.

The advertisements appropriate for each consumer are send in step S406. A preferably uninterrupted media stream is displayed in step S408, including the appropriately matched advertisements.

FIG. 4B is a flowchart in accordance with another example embodiment. FIG. 4B is similar to FIG. 4A, and a discussion of like steps will be omitted. In step S410 all advertisements for all categories for a given commercial break are transmitted to all consumers. Then, step S412 applies a filter to eliminate the advertisements that do not match with the consumer's demographic data.

It will be appreciated that although the example embodiments have been described in terms of “push” systems in which broadcasters send media streams and ad groups, the present invention is not so limited. Some example embodiments may employ “pull” systems, wherein televisions and/or devices request media streams and/or specific ad groups. Furthermore, other example embodiments may comprise a combination of push and pull techniques by, for example, pushing feature content and pulling ad groups. Additionally, while the example embodiments have been described with respect to television, the present invention is not so limited. Analogous embodiments may be suitable for other mediums of communication, such as, for example, radio, Internet, etc.

While certain preferred embodiments relate to displaying customized advertisements via televisions, this invention as discussed above is not so limited. For example, in alternative embodiments of this invention the customized advertisements may be broadcast via radio (e.g., satellite radio). In satellite radio systems, particular radio receivers can be identified; e.g., each receiver can be programmed (e.g., remotely) so as to received certain customized advertisements based on the demographics of the user/owner as discussed above with respect to the television embodiments of this invention. Thus, it is possible for a radio (e.g., satellite radio) to replace the television in any of the embodiments herein.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A system for displaying targeted advertisements on television, the system comprising:
at least one custom category;
a database of demographic data including at least one characteristic for a potential consumer and an addressable location for said potential consumer;
a matcher for associating said potential consumer with at least one custom category;
a processor for generating a customized media stream of generic content and at least one targeted advertisement for said potential consumer, based on information generated by the matcher; and,
a broadcasting mechanism for disseminating to said addressable location said customized media stream for display on a television of the potential consumer.

2. The system of claim 1, wherein said demographic data is obtained from a credit card company.

3. The system of claim 1, wherein said broadcasting mechanism disseminates media streams by one or more of a cable system, a satellite, standard broadcast television, and/or the Internet.

4. The system of claim 1, wherein said database of demographic data is updatable.

5. The system of claim 4, wherein said association between said potential consumer and said at least one custom category is updated when or after said database of demographic data is updated.

6. The system of claim 1, wherein said matcher associates a potential consumer with at least one custom category through the use of one or more of a predefined heuristic, a custom user operation, a standardized industry groupings and/or a mathematical clustering technique.

7. The system of claim 1, wherein said at least one custom category is based on one or more of an industry standard list, a consumer's preference, and/or a mathematical clustering technique.

8. A system for displaying targeted advertisements comprising:
at least one custom category;
a database of demographic data including at least one characteristic for a potential consumer;
matching means for associating said potential consumer with at least one custom category;
a processor for generating a media stream of content and potential targeted advertisements for potential consumers;
a broadcasting mechanism for disseminating said media stream; and,
a filter that removes or blocks from the media stream at least some targeted advertisements that do not match the association created by said matching means.

9. The system of claim 8, wherein said demographic data is obtained from a credit card company.

10. The system of claim 8, wherein said broadcasting mechanism disseminates media streams by one or more of a cable system, a satellite, standard broadcast television, and/or the Internet.

11. The system of claim 8, wherein said database of demographic data is updatable.

12. The system of claim 11, wherein said association between said potential consumer and said at least one custom category is updated when or after said database of demographic data is updated.

13. The system of claim 8, wherein said matching means associates a potential consumer with at least one custom category through the use of one or more of a predefined heuristic, a custom user operation, a standardized industry groupings and/or a mathematical clustering technique.

14. The system of claim 8, wherein said at least one custom category is based on at least one of an industry standard list, a consumer's preference, and/or a mathematical clustering technique.

15. The system of claim 8, wherein said targeted advertisements are compressed before transmission and decompressed before display.

16. A method for displaying targeted advertisements comprising:
defining at least one custom category;
obtaining a database of demographic data including at least one characteristic for a potential consumer and an addressable location for said potential consumer;
matching said potential consumer with at least one custom category;
generating a customized media stream of generic content and at least one targeted advertisement for said potential consumer based at least in part on said matching; and,
broadcasting to said addressable location said customized media stream.

17. The method of claim 16, wherein said demographic data is obtained from a credit card company.

18. The method of claim 16, wherein said broadcasting step disseminates media streams by one or more of a cable system, a satellite, standard broadcast television, and/or the Internet.

19. The method of claim 16, wherein said matching associates a potential consumer with at least one custom category through the use of one or more of a predefined heuristic, a custom user operation, a standardized industry groupings and/or a mathematical clustering technique.

20. The method of claim 16, wherein said defining at least one custom category is based on at least one of an industry standard list, a consumer's preference, and/or a mathematical clustering technique.

21. A method for broadcasting targeted advertisements via satellite radio or television, the method comprising:
defining at least one custom category;
obtaining a database of demographic data including at least one characteristic for a potential consumer and an addressable location for said potential consumer;
matching said potential consumer with at least one custom category;
generating a customized media stream of generic content and at least one targeted advertisement for said potential consumer based at least in part on said matching; and,
broadcasting to said addressable location said customized media stream via satellite radio or television.
